(19) United States
(12) Patent Application Publication
(10) Pub. No.: US 2005/0027560 A1
(43) Pub. Date: Feb. 3, 2005

(54) Interactive multi-user medication and medical history management method

(76) Inventor: Deborah Cook, Forest, OH (US)

Correspondence Address: GALLAGHER & DAWSEY CO., L.P.A., P.O. BOX 785, COLUMBUS, OH, 43216, US

(21) Appl. No.: 10/628,589

(22) Filed: Jul. 28, 2003

(51) Int. Cl. G06F 17/60

(52) U.S. Cl. 705/2

(57) ABSTRACT

An interactive multi-user medication and medical history management method is provided contained in a memory medium. Users create patient records, including patient medical history and patient mediation profiles, and employ access permission level assignments that provide different levels of access to different users. Patient medical records may be organized into groups such that users such as physicians, institution, or other parties may aggregate a plurality of records. Information regarding prescribed medications is provided in part by master medication library, which may contain accurate pictorial representations for a plurality of medications, and which may be frequently updated to provide up to the minute information regarding medications. Reports may be generated from patient medical records in a near limitless number of formats and sizes. Software containing the method may be contained in one or more computer systems, which maybe in electronic communication via the Internet.

### TECHNICAL FIELD

The present invention relates to the field of medical information storage and retrieval methods and devices, particularly to a computer based drug history, dosing, and identification method and device.

### BACKGROUND OF THE INVENTION

Advancing age of the population, advances in medical treatment, and the growing complexity of drug treatment regimens are increasing the number of medications used by the populace. One researcher has estimated that almost 40 percent of the elderly in the Untied States take five or more different medicines each week. Particularly for this elderly population, a growing list of medications, combined with age and health related diminishment of vision and memory make remembering and taking proper medications a daunting task for many.

Failure to take medicine, or taking the correct medicine on the wrong schedule, or even taking the wrong medicine, can be disastrous events. Statistically, there are about 50 adverse drug events for every 1,000 people taking medications in the United States each year. Recently, a group of patients, all 65 years of age or older, and receiving outpatient medications only, found 1,523 adverse drug events annually in a population of 30,000. Extrapolated to the United States' population of the elderly, this study suggested that more than 190,000 adverse drug events occurred annually in a national group of 38 million. 27.6 percent of these adverse drug events were deemed preventable, while 38 percent of the events were considered serious, life threatening, or fatal. Significantly, the more serious events were found to be more preventable than some of the less serious medication related mistakes, with 42 percent of the most harmful events considered avoidable.

Adverse drug incidents have many causes; however, a major component of such events is failure to take medicine correctly. Studies have shown that as many as 50% of all prescriptions are taken incorrectly, despite the fact that assistance in taking medication is often available, with 80-90 percent of people requiring care in the United States receiving it from family or friends. It can be difficult for many persons to read the small print on drug packaging correctly, and the medications, often in pill or capsule form, can be small and hard to differentiate. A multitude of different dosing regimes makes it difficult, especially for one of diminished mental acuity, to take medications correctly. Since it often falls to a family member to assist with medications, these usually medically untrained individuals are faced with a both a daunting task and a serious responsibility to be accurate.

The opportunity for further errors and omissions occurs with every interaction between a patient and the health care system. Health providers such as doctors and pharmacists need to have an accurate list of a patient's medications in order to make correct diagnosis and treatment decisions. In particular, a full medication listing is important to screen for potential drug interactions with new or existing prescriptions. Patients, particularly the acutely ill or elderly, may have difficulty providing such an accurate description of their medication.

Various medication reminder type systems have been proposed. Among the simplest are various compartmented container-type devices, such as that seen in U.S. Pat. No. 6,550,618 to Peterson. This device provides a plurality of compartments, and a plurality of information cards containing drug information and photographs, that may be attached to the compartmented device. Such a device cannot be remotely accessed and cannot generate reports or medication schedules that can be easily carried or provided to third parties such as doctors or pharmacies.

What has been needed in the art is a reliable, easy to use, and cost effective means for persons taking medication to keep track of their medications and their dosage schedules, to have an easy way of identifying medications for themselves and those who help with their care, and a means for such a schedule to generate a plurality of types of reports and reminders, and for these schedules to be available, at least in read-only format, to authorized health providers and other interested parties.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways. In one of the simplest configurations, the interactive multi-user medication and medical history management method is carried out in a system comprising at least one memory medium comprising at least two databases; one containing at least one patient record, and another containing a master medication library containing a plurality of medication data representative of a plurality of medications; input means, and a display.

A new user enters and constructs a user profile and a patient record in the database containing the patient record, including both a patient medical history and a patient medication profile. Patient records may be organized into groups to facilitate access by users. For example, a group could be as small as one containing a single patient record. On the other hand, a group could be as large as desired, and could represent, for example, all the patient records belonging to those persons sharing a common health care provider, or health care institution, such as a hospital, other care facility, or pharmacy provider. Each group has at least one user who has editing permission for the group, that is, they have the ability to both read and write to the patient record. Other users may be granted read-only access to various groups by a read-only limiter, which will in turn grant read-only privileges to a plurality of patient records

The master medication library database contains a plurality of information representative of a plurality of medications and may contain pictorial representations of a plurality of medications that give accurate visual representations of the actual appearance of the medications in their various formulations.

In one embodiment, the interactive multi-user medication and medical history management method is initiated with the step of creating at least one use profile by means of an input means in electronic communication with the memory medium. The user may have the option of creating new patient records and may be directed to specify the registration of a single patient record, or may sequentially create multiple patient records within a user group. Returning users may have the option of signing in using a previously created user name and password.

Next, the method includes the step of generating at least one patient record including at least a patient medical history and a patient medication profile. The patient medical history may contain a plurality of medical information for a predetermined patient and may also contain a plurality of medically related information, such as the names of preferred doctors, hospitals and pharmacies; emergency contact information, and advance directives on organ donation or patient instructions on the employment of extensive life support means. The patient medication profile may also contain a plurality of medication information for a predetermined patient, for example, such information as the names of prescribed medication taken, and including at least one medication formulation requirement representing the mode in which the prescribed medication is taken, and at least one medication administration requirement representing the dosage strength and schedule with which the prescribed medication is taken. The patient medical history allergy information may include an allergy alert profile containing known allergies for each of the at least one patient records, or a drug interaction profile representing known drug interactions for the prescribed medications. Warning indicia may be configured in multiple manners and may simply not allow prescribed medications to be entered into the patient medication profile if that prescribed medication is associated with any contraindicating allergy information or known drug interactions in the patient medical history.

The method is configured to apply a user specified report generating filter to the at least one patient record, the master medication library, and the user profile to create and display at least one administration and history report. Displays of generated reports may take many forms and the at least one administration and history report may include at least one prescribed medication pictorial representation of each of the at least one prescribed medications. Reports may be displayed on computer screens, or in hard copy format. Such hard copy formats may include, for example, relatively large sized reports that may appear on a desk or be posted on a cupboard or refrigerator for easy reference. Conversely, reports may be generated in smaller hard copy versions, which, for example, may be sized for ease of use and handling as a wallet sized administration and history.

Administration and history reports, including the pictorial representation of the at least one medication, may be tailored in size to accommodate persons of variable visual acuity. For example, pictorial representations may be larger than actual size to facilitate recognition, may be the same as actual size to allow overlaying the medication on the pictorial representation for identification, or may be smaller than actual size, to conserve space on wallet or other small sized administration and history reports. Virtually any information that will be beneficial to the patient or helpful to his or her compliance with medication may be incorporated into the administration and history reports.

Hardware associated with the method may be designed in a plurality of means. For example, the at least one memory medium wherein the predetermined master medication library resides may be located in a first computer system in communication with a separate and distinct second computer system wherein the user profile creation step is initiated, wherein the report generating filter applying step is initiated, and wherein the display occurs. By way of example and not limitation, in such an embodiment, the master medication library may be contained in a first computer system that is in communication with the second computer system by means of Internet communication. Conversely, the master medication library and software for the generation and maintenance of the patient record and display functions may be supplied to a single computer system, by means such as downloads from the Internet or on compact discs.

Regardless of where the master medication library is stored, one of the improvements made to the current art by the instant invention is the ease with which the master medication library may be kept current. If the master medication library is contained in a first computer system, and is made available to users, by way of example, as on online subscription service, professional managers can make daily, or even more often, changes to the master medication library to make sure that subscribers receive literally up to the minute drug information. If the master medication library is contained with the software for the generation and maintenance of the patient record and display functions on the same computer, users can periodically download updates to the master medication library through either the Internet or via hard media such as compact discs.

The ability to fluidly associate patient records with various groups is another great advance to the current art made by the instant invention. Parties who may have legitimate need for some or all of the information contained in some or all of the patient records may be granted such access, while maintaining the safety and security of the system for the ultimate beneficiary, the patient.

Lastly, the method advances the art in its ability to generate a nearly limitless variety of administration history reports, which can be customized so as to best meet the needs and wishes of those using the method.

### BRIEF DESCRIPTION OF THE DRAWINGS

Without limiting the scope of the present invention as claimed below and referring now to the drawings and figures:

FIG. 1 shows a diagram of the interactive multi-user medication and medical history management method of the instant invention;

FIG. 2 shows a software diagram of the interactive multi-user medication and medical history management method of the instant invention;

FIG. 3 shows an embodiment of a patient medication profile from the method;

FIG. 4 shows an embodiment of an administration and history report from the method;

FIG. 5 shows a variation in the administration and history report of FIG. 4;

FIG. 6 shows the Log In Module of one embodiment of the method;

FIG. 7 shows details from the Log In Module of FIG. 6 of one embodiment of the method;

FIG. 8 shows the Menu Module of one embodiment of the method;

FIG. 9 shows a part of the Patient Module of one embodiment of the method;

FIG. 10 shows the remainder of the Patient Module of FIG. 9 from the method;

FIG. 11 shows the Basic Editor Module of one embodiment of the method;

FIG. 12 shows the Group Module of one embodiment of the method;

FIG. 13 shows the Patient Permission Module of one embodiment of the method;

FIG. 14 shows the Group Permission Module of one embodiment of the method; and

FIG. 15 shows the Report Module of one embodiment of the method.

### DETAILED DESCRIPTION OF THE INVENTION

The instant invention enables a significant advance in the state of the art. The preferred embodiments of the apparatus accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

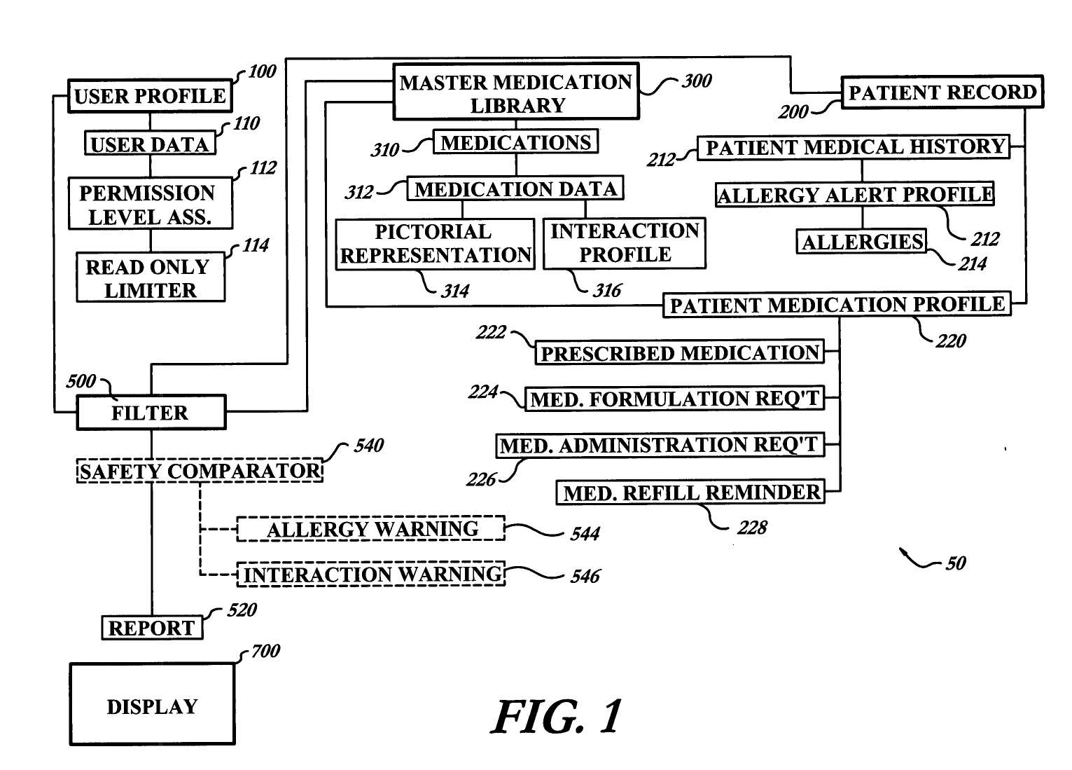

In one basic embodiment, seen in FIGS. 1- 15, the interactive multi-user medication and medical history management method 50 is carried out in a system comprising, in at least one memory medium, at least two databases; one containing at least one patient record 200, and another containing a master medication library 300 containing a plurality of medication data 312 representative of a plurality of medications 310; input means, and a display 700 for visual display of reports generated from these databases.

As seen in FIG. 1, a user, subject to provided user data 110 and access permission level assignments 112 that determine their privileges within the system, enters and constructs a user profile 100 and a patient record 200 in the database containing the patient record 200. The patient record 200 includes both a patient medical history 210 and a patient medication profile 220. The patient medical history 210 may include, for example, such information as significant illnesses, surgeries, known allergies 214, and drug sensitivities. The patient medication profile 220 may include at least information concerning at least one prescribed medication 222 for an individual patient, including, for example, such information as medication name; administration route or mode, denominated the medication formulation requirement 224; and dose strength and schedule, denominated the medication administration requirement 226. Prescribed medication 222 is contemplated to also include medications 222 and supplements which the patient obtains without a doctor's prescription.

Formation of the patient record 200 may include cross-referencing the patient allergies 214 and drug sensitivities against the prescribed medications 222 contained in the patient medication profile 220, in order to create an allergy alert profile 212 to detect and alert the user to any common elements occurring in both the patient medical history 210 and the patient medication profile 220. The patient record 200 may include numerous other items of information; for example, the patient medical history 210 may include user input information such as anatomical donation information or other medical commentary. Similarly, the patient medication profile 220 may calculate the date when a patient will run out of a given prescribed medication 222 by counting the days, based on supply of prescribed medication 222 and daily consumption, and generate a medication refill reminder at a predetermined time in advance of the consumption down to some minimum amount of medication remaining.

Patient records 200 may be organized into groups to facilitate access by users. For example, a group could be as small as one containing a single patient record 200. On the other hand, a group could be as large as desired, and could represent, for example, all the patient records 200 belonging to those persons sharing a common health care provider, or health care institution, such as a hospital, other care facility, or pharmacy provider.

Each group has at least one user who has editing permission for the group, that is, they have the ability to both read and write to the patient record 200. Other users may be granted read-only access to various groups by a read-only limiter 114, which will in turn grant read-only privileges to a plurality of patient records 200. At least one access permission level assignment 112 for each of the at least one user profiles 100 thereby associates any of the at least one patient records 200 with any of the at least one access permission level assignments 112, thereby permitting a user, associated with the user data 110, to access only the at least one patient record 200 associated with the at least one access permission level assignment 112.

The master medication library 300 database contains a plurality of information representative of a plurality of medications 310. This information may include, by way of example and not limitation, such information as drug names; including trade names, chemical names, and common generic names; commercially available drug formulations; drug strengths; drug indications; standard dosing schedules; and known drug interactions. The master medication library may contain pictorial representations 314 of a plurality of medications 310 that give accurate visual representations of the actual appearance of the medications 310 in their various formulations.

In one embodiment, seen in FIG. 1, the interactive multi-user medication and medical history management method 50 is initiated with the step of creating at least one use profile 100 by entering a plurality of user data 110. A prospective user accesses the system by means of an input means in electronic communication with the memory medium. Such input means may include, by way of example and not limitation, both wired and wireless means such as keyboards, touch screens, or personal data assistants (PDAs). User prompts may guide a new user through the process of creating a user name and a password. Returning users may have the option of signing in using a previously created user name and password.

The user may have the option of creating new patient records 200, which may include the use of user input data 110 to determine at least one permission level assignment 112. For example, the permission level assignment 112 may include the ability to both read and write to patient records 200, or may employ a read-only limiter 114 to allow read-only access to patient records 200. Read-only access may be further limited to certain predetermined patient records 200 contained in predetermined user groups. At least one read-only limiter 114, associated with at least a portion of the at least one patient record 200, may enable the user to view the at least one patient record 200 associated with the at least one access permission level assignment 112, but guard the permitted patient records 200 from modification by the user. If the user seeks to create a patient record 200, the user may be directed to specify the registration of a single patient record 200, or may sequentially create multiple patient records 200 within a user group.

Next, the method 50 includes the step of generating at least one patient record 200 including at least a patient medical history 210 and a patient medication profile 220. The patient medical history 210 may contain a plurality of medical information for a predetermined patient, for example, such information as past and present medical illnesses, surgeries, allergies 214, and known drug reactions. The patient medical history 210 may also contain a plurality of medically related information, such as the names of preferred doctors, hospitals and pharmacies; emergency contact information, and advance directives on organ donation or patient instructions on the employment of extensive life support means. The patient medication profile 220 may contain a plurality of medication information for a predetermined patient, for example, such information as the names of prescribed medication 222 taken, and including at least one medication formulation requirement 224 representing the mode in which the prescribed medication 222 is taken, and at least one medication administration requirement 226 representing the dosage strength and schedule with which the prescribed medication 222 is taken. The patient medical history 210 allergy information may include an allergy alert profile 212 containing known allergies 214 for each of the at least one patient records 200, and the method 50 may include the step of comparing the allergy alert profile 212 by an allergy comparator 542 means with each of the at least one prescribed medications 222 and displaying allergy warning indicia 544 for any of the at least one prescribed medications 222 appearing in the allergy alert profile 212. The allergy warning indicia 544 may be configured in multiple manners, including for example, warnings shown on the display 700, or in the administration and history reports 600, or may simply not allow prescribed medications 222 to be entered into the patient medication profile 220 if that prescribed medication 222 is associated with any contraindicating allergy information in the patient medical history 210. In embodiments that prevent prescribed medications 222 from being entered into the patient medication profile 220 if that prescribed medication is associated with any contraindicating allergy information in the patient medical history, overrides of such blocking may be allowed by authorized users under controlled circumstances.

Similarly, within the master medication library, the plurality of medication data 312 for the medications 310 may include a drug interaction profile 316 for each of the plurality of medications 310, and the method 50 may further comprise the step of comparing the drug interaction profile 316 by an interaction comparator 546 when more than one prescribed medications 222 is entered in the patient medication profile 220 and displaying at least one interaction warning indicia 548 for any of the at least one prescribed medications 220 known to interact with any other of the at least one prescribed medications 222 in the patient medication profile 220. The interaction warning indicia 548 may be configured in multiple manners, including for example, warnings shown on the display 700, or in the administration and history reports 600, or may simply not allow prescribed medications 222 to be entered into the patient medication profile 220 if that prescribed medication 222 is associated with any contraindicating drug interaction information in the patient medical history 210. In embodiments that prevent prescribed medications 222 from being entered into the patient medication profile 220 if that prescribed medication is associated with any contraindicating drug interaction information in the patient medical history, overrides of such blocking may be allowed by authorized users under controlled circumstances.

The master medication library 300 may also include medication pictorial representations 314 as part of the medication data 312 for each of the medications 310, as will be discussed at length below.

The method 50 is configured to apply a user specified report generating filter 500 to the at least one patient record 200, the master medication library 300, and the user profile 100 to create and display at least one administration and history report 600. For example, the filter may direct that not all information from the patient record 200 and the master medication library appear in any particular administration and history report 600. Additionally, the filter 500 may block certain users from having full access to certain information from the patient record 200. Such administration and history reports 600 may be configured in virtually any form to suit the individual user or patient. For example, prescribed medications 222 may be organized, and displayed with prescribed medication pictorial representations 610 for each prescribed medication 222, by sequential time of day of administration, or for drugs to be taken at certain times of day such as on arising or at bedtime, or by purpose for each prescribed medication 222, that is for the illness or condition being treated. Prescribed medications 222 may be grouped by formulation categories, such as pills, capsules, or liquids; or by medical indication categories, such as diuretics, heart, or diabetic medications.

Application of the report generating filter 500 may include the step of comparing the allergy alert profile 212 with each of the at least one prescribed medications 222 each time the filter 500 is applied and may also include the step of displaying allergy warning indicia 544 for any of the at least one prescribed medications 222 appearing in the allergy alert profile 212. In one embodiment, the filter 500 is applied each time the method 50 is accessed, and allergy warning indicia 544 may be displayed anew with each accessing of the patient record 200.

Displays of generated reports may take many forms and the at least one administration and history report 600 may include at least one prescribed medication pictorial representation 610 of each of the at least one prescribed medications 222. For example, reports may be displayed on a plurality of monitors, such as computer screens. Additionally, reports may be generated in a hard copy format. Such hard copy formats may include, for example, relatively large sized reports that may appear on a desk or be posted on a cupboard or refrigerator for easy reference. Conversely, reports may generated in smaller hard copy versions, which, for example, may be sized for ease of use and handling as a wallet sized administration and history report 520 or to be printed on a medication bottle report 530, formed as a label or sticker.

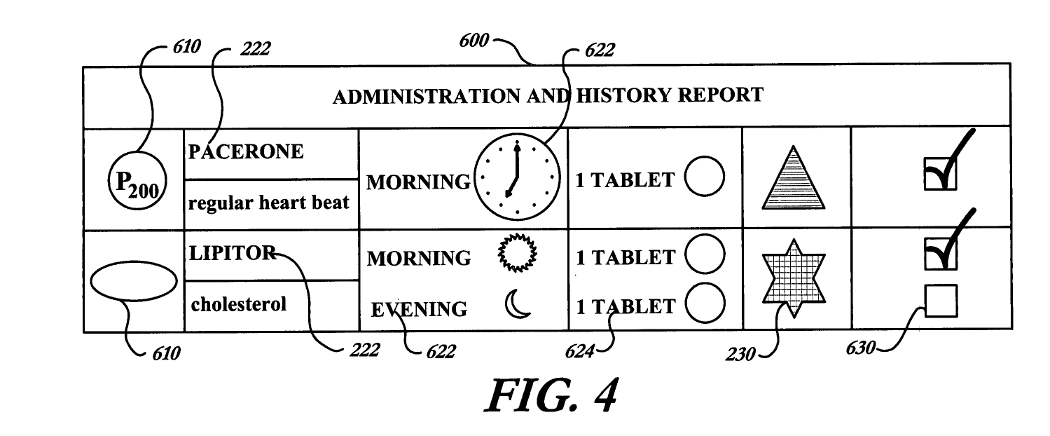

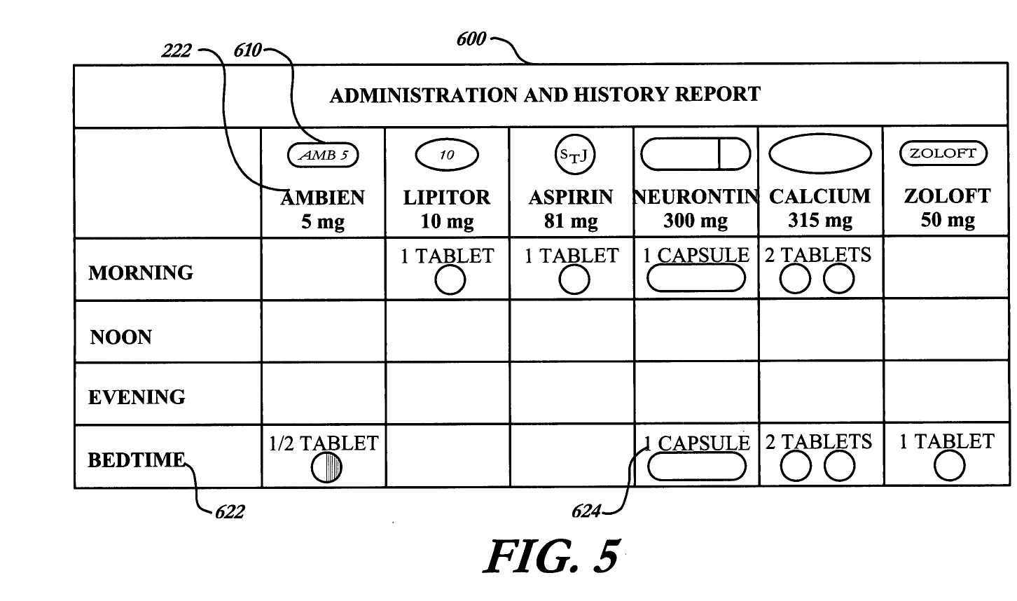

A sample embodiment of a patient medical profile 220 is seen in FIG. 3 and sample embodiment administration and history reports 600 based on such patient medical profiles are seen in FIGS. 4 and 5. In FIG. 3, the patient medical profile 220 is configured in the form of a chart showing, for a predetermined patient, a prescribed medication 222 printed above a brief description of the condition for which the medication is prescribed, a medication formulation requirement 224 showing in both symbolic pictorial form and text form the dosage which is to be taken, a medication administration requirement 226 showing in both symbolic and text form the time of day at which the medication is to be taken, a medication pictorial representation 314 for the prescribed medication 222, and a container identifier 230. The container identifier 230 may be a pictorial symbol that matches graphic symbols attached to various medication containers, and such matching indicia may be formed in distinctive shapes and/or colors. By such container identifier 230 means, patients, including the visually impaired, are easily directed to the correct bottle to find the medication desired.

Administration and history reports, including the pictorial representation 610 of the at least one medication 222, may be tailored in size to accommodate persons of variable visual acuity. For example, pictorial representations 610 may be larger than actual size to facilitate recognition, may be the same as actual size to allow overlaying the medication on the pictorial representation 610 for identification, or may be smaller than actual size, to conserve space on wallet 520 or other small sized administration and history reports 600.

Virtually any information that will be beneficial to the patient or helpful to his or her compliance with prescribed medication 222 may be incorporated into the administration and history reports 600. For example, in the sample embodiment administration and history report seen in FIG. 4, the user has elected to include indicia such as prescribed medication pictorial representation 610, time of administration indicia 622, method of administration indicia 624, container identifiers 230, and administration verification 630, which in this sample embodiment, takes the form of boxes that the patient can check off after taking the medication.

Displays may include monitoring the patient's supply of prescribed medication 222. The method 50 may monitor a patient's medication supplies by generating at least one medication refill reminder a predetermined number of days prior to the exhaustion of the at least one prescribed medication 222 by utilizing the at least one medication formulation requirement 224 and the at least one medication administration requirement 226, and then counting down until a projected date and time of supply exhaustion is calculated. At least one medication refill reminder may be automatically emailed to the patient or any other predetermined person based on this calculation.

Hardware associated with the method 50 may be designed in a plurality of means. For example, the at least one memory medium wherein the predetermined master medication library 300 resides may be located in a first computer system in communication with a separate and distinct second computer system wherein the user profile 100 creation step is initiated, wherein the report generating filter 500 applying step is initiated, and wherein the display 700 occurs. By way of example and not limitation, in such an embodiment, the master medication library 300 may be contained in a first computer system that is in communication with the second computer system by means of Internet communication. Conversely, the master medication library 300 and software for the generation and maintenance of the patient record 200 and display 700 functions may be supplied to a single computer system, by means such as downloads from the Internet or on compact discs.

Regardless of where the master medication library 300 is stored, one of the improvements made to the current art by the instant invention is the ease with which the master medication library 300 may be kept current. If the master medication library is contained in a first computer system, and is made available to users, by way of example, as on online subscription service, professional managers can make daily, or even more often, changes to the master medication library to make sure that subscribers receive literally up to the minute drug information. If the master medication library 300 is contained with the software for the generation and maintenance of the patient record 200 and display 700 functions on the same computer, users can periodically download updates to the master medication library 300 through either the media or via hard media such as compact discs.

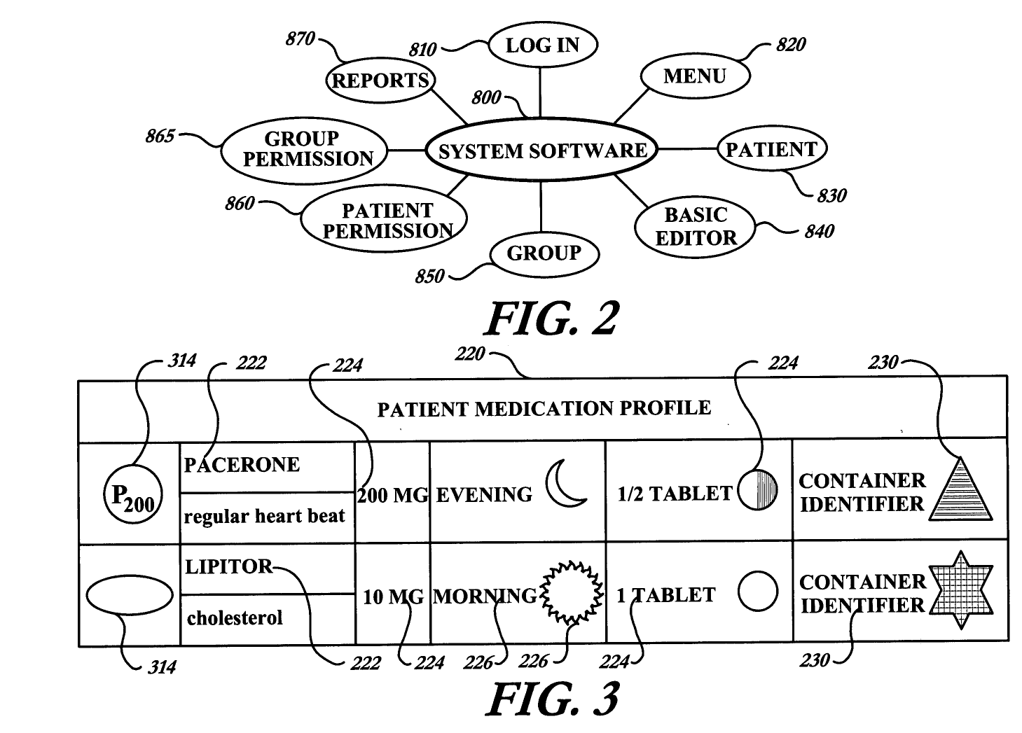

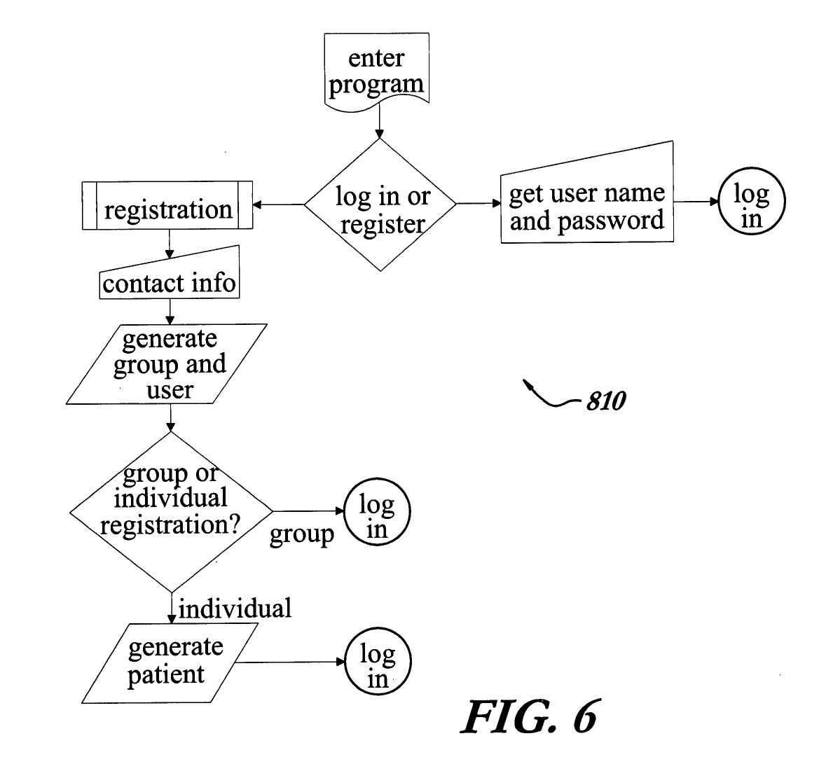

In one embodiment, the interactive multi-user medication and medical history management method 50 proceeds according to software diagram seen in FIG. 2 and the flow charts seen in FIGS. 6-15. FIG. 2 shows an outline of the basic modules that go to make up the system software 800; the Log In Module 810, the Menu Module 820, the Patient Module 830, the Basic Editor Module 840, the Group Module 850, a Permissions Module that is divided between the Patient Permission Module 860 and the Group Permission Module 865, and the Report Module 870. Each of these modules will be detailed individually below. FIGS. 6-15 show step-specific flow charts for one contemplated embodiment of the instant invention.

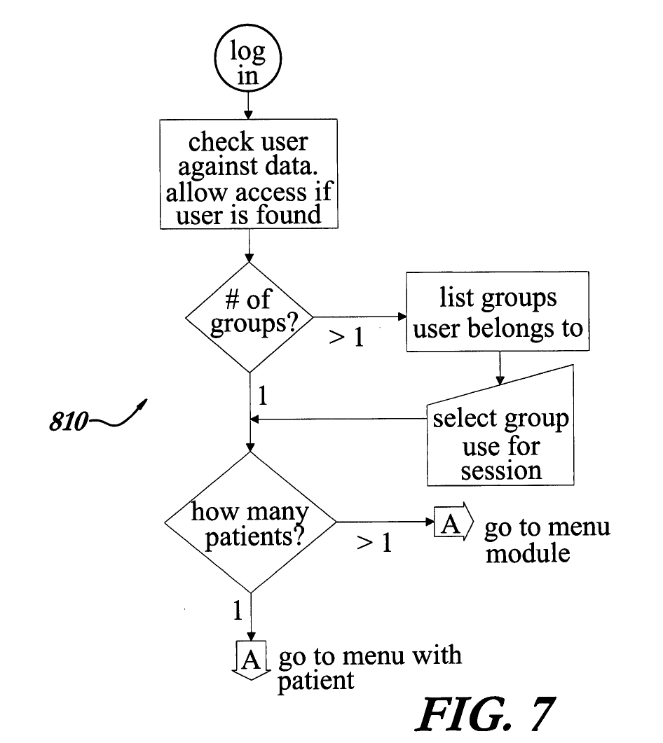

The step previously identified as generating the user profiles 100 begins with entering the program through a Log In Module 810 as seen in FIG. 6. A proposed user is prompted to register, for new users, or to log in, for past users. Those past users logging in are prompted for their user name and password, as seen in FIG. 7. If the user name and password are found in previously input data, the proposed user is logged in and becomes a user. User profiles 100 are associated with groups. In the simplest embodiment, a group can be as small as one containing a single patient record 200. In more complex embodiments, groups may contain a plurality of users and patient records 200. By way of example and not limitation, a group comprising the patients of a given doctor might comprise several hundred patient records 200. Every user is owned by a group, but not every group owns any users; for example, an individual patient may constitute a group that owns the user profile 100 representing the patient record 200 for that particular patient. Additionally, access to that patient record 200 may be granted to other groups, such as physicians, pharmacists, or other health care providers or institutions, which would have some degree of less than the highest access permission level assignment 112 to that patient record 200.

The ability to fluidly associate patient records 200 with various groups is another great advance to the current art made by the instant invention. Parties who may have legitimate need for some or all of the information contained in some or all of the patient records 200 may be granted such access, while maintaining the safety and security of the system for the ultimate beneficiary, the patient.

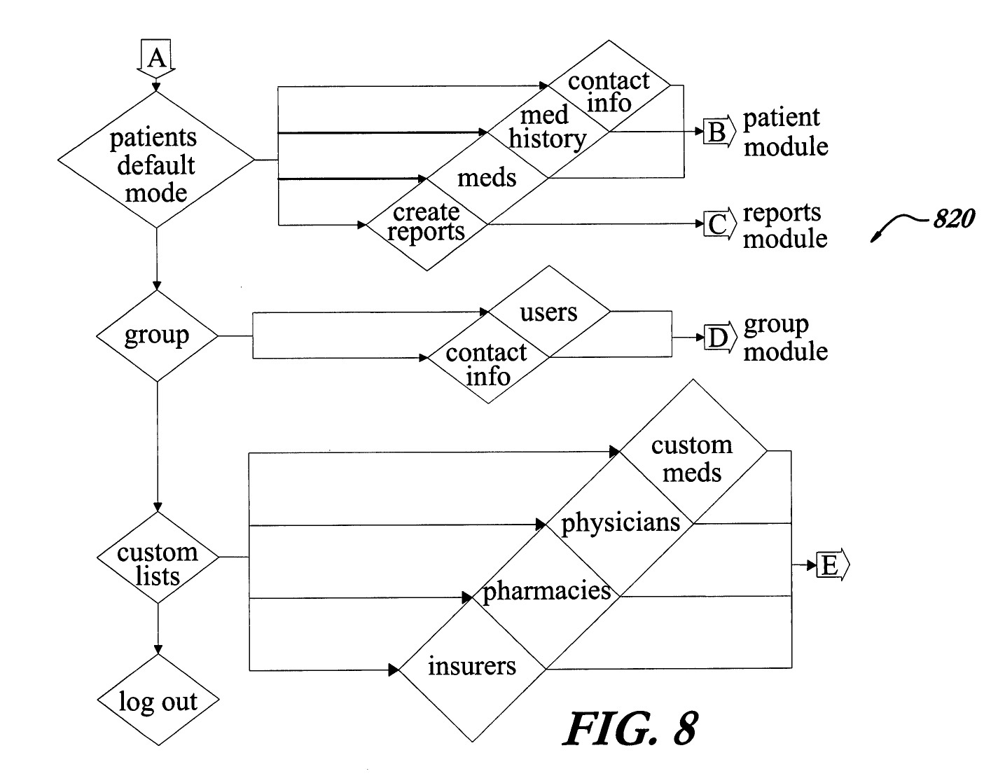

If the user profile 100 associated with that user belongs to more than one group, a list of groups that the user belongs to is displayed and the user is prompted to select one of the groups. When a group is selected, or if the user belongs to only a single group, a list of patients associated with patient records 200 is displayed. When a patient is selected, or if the group contains only one patient, the user is directed directly to the specific patient, as seen in the Menu Module 820 in FIG. 8.

For new users, the Log In Module 810, seen in FIGS. 6 and 7, begins the generation of new user profiles 100 and new patient records 200. At the log in or register prompt, a new user selects registration and is prompted to generate contact information for that user, and is allowed to generate both a group and a user profile 100. The user is then prompted to specify a group or an individual registration. If an individual registration is selected, a group and user profile 100 is associated with a single patient record 200. This patient record 200 may be generated automatically from the contact information already collected. Group registrations, on the other hand, do not automatically lead to the generation of patient records 200, but instead allows the manual creation of a plurality of patient records 200 to be associated with that group. Once a patient record 200 is generated, new users and returning users converge at the Menu Module 820, as seen in FIG. 8.

In this embodiment, the Menu Module 820 is the point of access to read, edit, and generate administration and history reports 600 from patient records 200, as well as the point of exit from the method 50. The default mode is to enter the Menu Module 820 at the patient record 200, although prompts will allow the user to instead select group or to generate custom lists, as seen in FIG. 8.

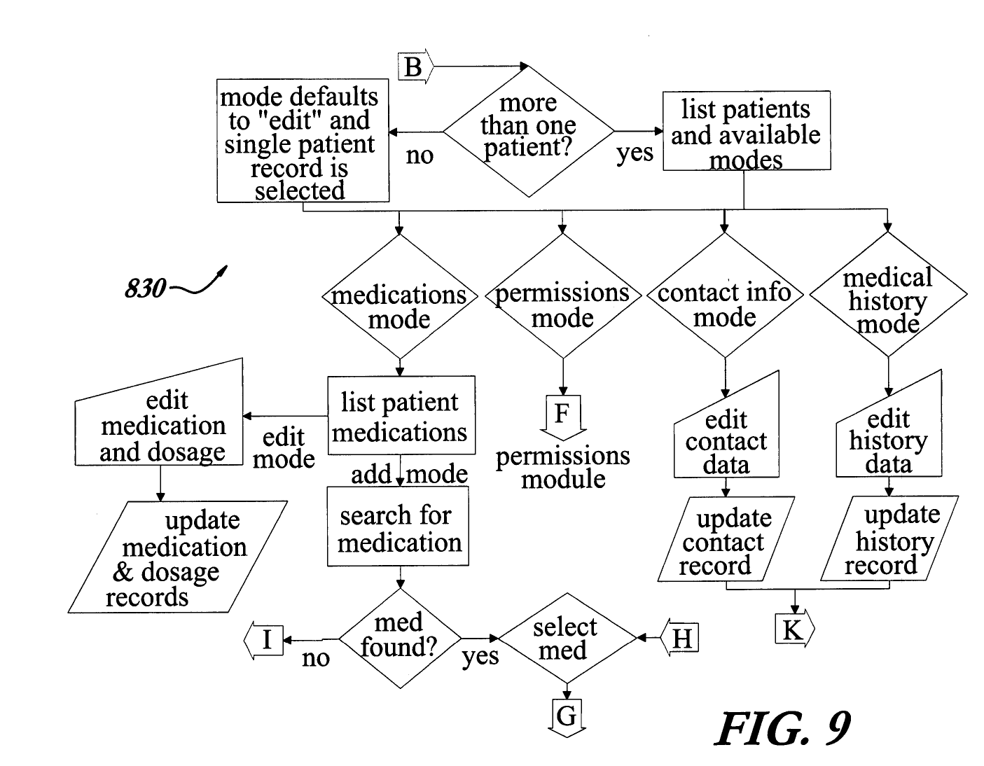

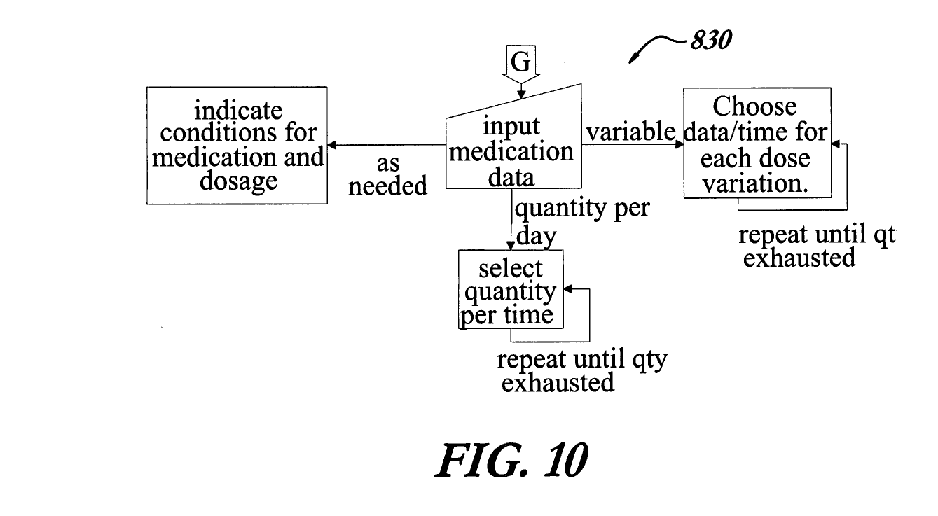

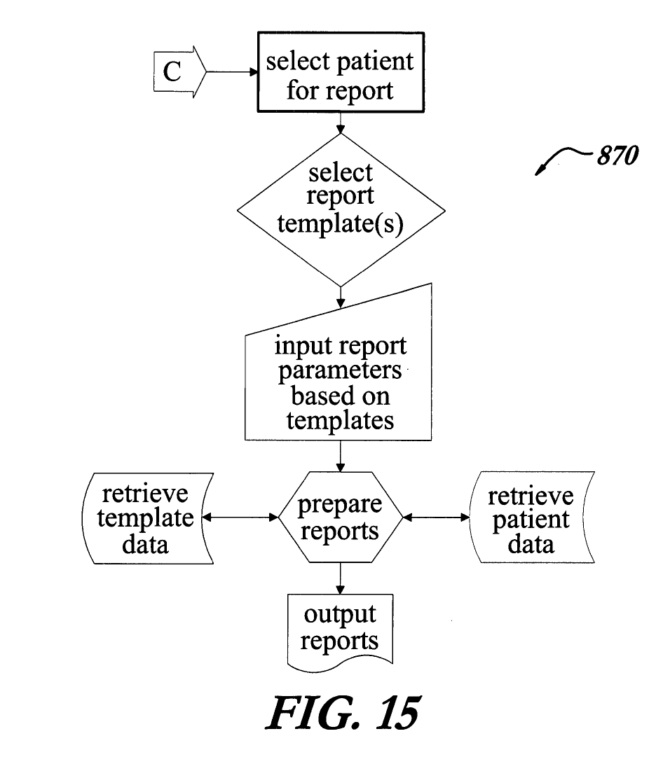

Within the patient record 200, the user is able to access further modules that allow access and possibly editing of contact information for the patient, the patient medical history 212, the patient medical profile 220, and to generate administration and history reports 600, as seen in FIG. 8. The Patient Module 830, seen in FIG. 9, controls patient information, and the Reports Module 870, seen in FIG. 15, generates administration and history reports 600.

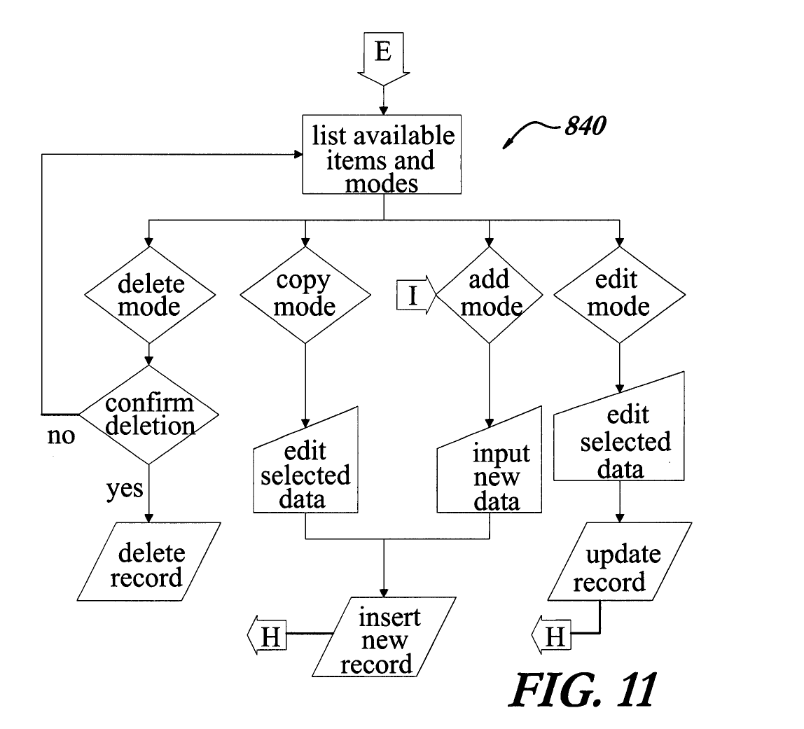

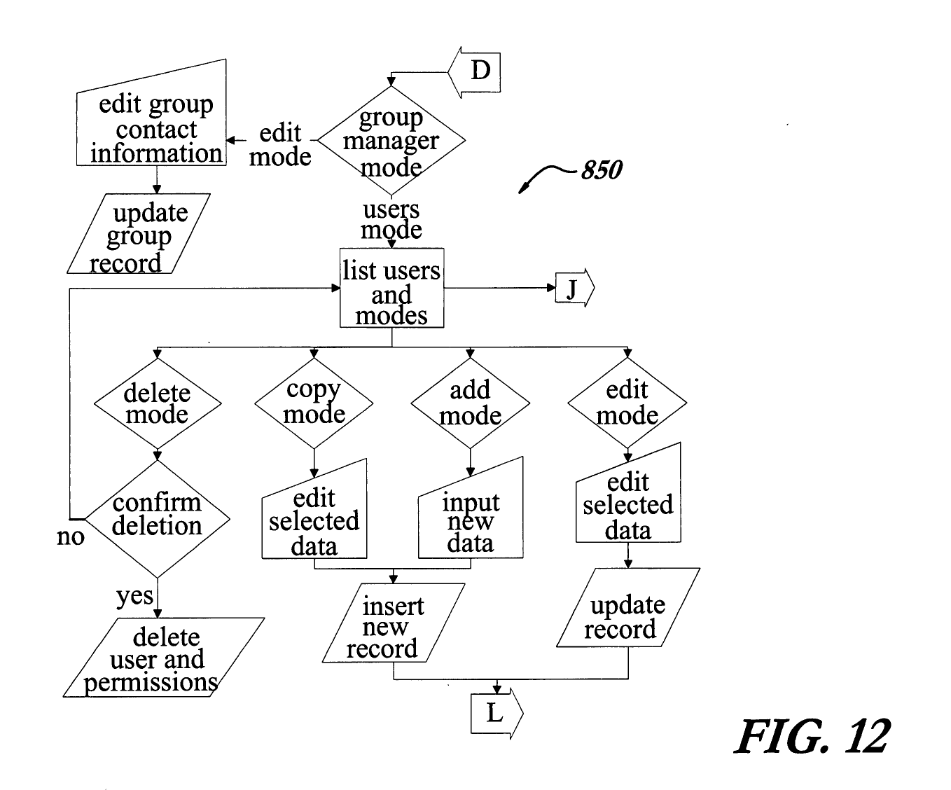

Referring again to FIG. 8, if instead of continuing into the patient record 200 from the Menu Module 820, the user instead selects group or custom lists, the user is instead directed to the Group Module 850, seen in FIG. 12; or the custom list function through the Basic Editor Module 840, seen in FIG. 11.

In this contemplated embodiment, those users entering the Patient Module 830, seen in FIG. 9, from the Menu Module 820, seen in FIG. 8, will initially be asked to specify whether there is more than one patient record 200 that is to be monitored. Users specifying a single patient record 200 will be directly routed to that patient record 200, while those specifying a plurality of patient records 200 will first need to specify the desired patient record 200 from a list of available patient records 200.

Continuing in the Patient Module 830 as seen in FIG. 9, the user will select from such editing modes as a Permissions Mode, a Contact Information Mode, a Medical History Mode containing the patient medical history 210, and a Medications Mode containing the patient medication profile 220.

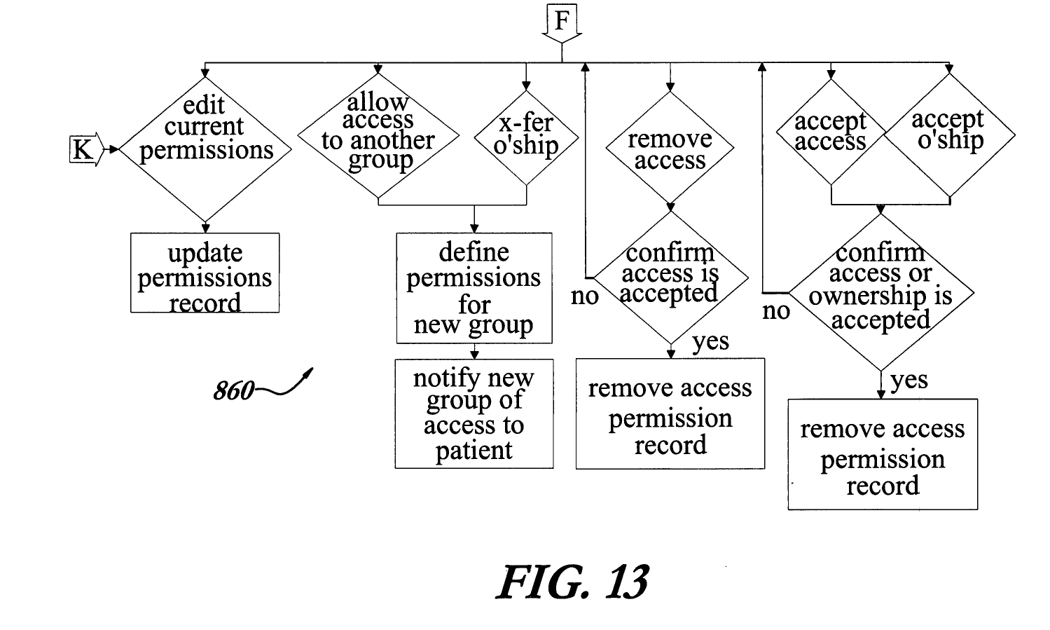

The selection of, or automatic routing to, the Permissions Mode will direct the user into the Permissions Module 860, as seen in FIG. 13, where permissions to manipulate various patient records 200 are protected by employing access permission level assignments 112 to regulate access to various functions.

The selection of the Contact Information Mode, as seen in FIG. 9, will allow editing and updating of patient contact information, followed by routing to the Permissions Module 860, seen in FIG. 13, to update access permission level assignments 112. The selection of the Medical History Mode, also seen in FIG. 9, will allow editing of information contained in the patient medical history 210, followed by routing to the Permissions Module 860, seen in FIG. 13, to update access permission level assignments 112.

The election of the Medications Mode, as seen in FIG. 9 will allow the user to edit the patient medication profile 220. A list of all patient medication will be displayed on the display means 700 and the user will be prompted to select either an Edit mode or an Add Mode, also seen in FIG. 9. The Edit Mode will allow the user to update information regarding prescribed medications 222 already present in the patient medication profile 220. Selection of the Add Mode will prompt the user to enter, through the input means, the name of the prescribed medication 222 that is to be added. The name of the prescribed medication 222 may be entered through a plurality of pull down menus organized as to various drug classifications, or may be entered through alphanumeric input. The method may employ means to search for near matches as well as exact matches to alphanumeric input to help guide users who may make errors in inputting information.

The method 50 will then access and search the master medication library 300 for the specified prescribed medication 222. If the prescribed medication 222 is found in the master medication library 300, the user will be prompted, as seen in FIG. 10, to select a medication formulation requirement 224 representing the mode of administration and a medication administration requirement 226 representing dosage strength and times for administration of the prescribed medication 222. The user may enter such information as the number of doses prescribed. The method 50 may use information such as the number of doses prescribed and the time and dose for regularly scheduled prescribed medications 222 to calculate the expected renewal date and to generate a medication refill reminder, which may be displayed and/or emailed to the user, patient, or other predetermined party.

If a prescribed medication 222 is not found in the master medical library 300, the user will be directed to the Add Mode in the Basic Editor Module 840, as seen in FIG. 11. The Add Mode will allow the user to manually add new prescribed medications 222, including such required information as a medication formulation requirement 224 and a medication administration requirement 226, to the patient medication profile 220. The Reports Module 870, seen in FIG. 15, may be accessed through the Menu Module 820, seen in FIG. 8.

The Reports Module 870, seen in FIG. 15, has the capacity to generate a plurality of reports based on report templates that employ a report generating filter 500 to access the at least one memory medium. The method 50 employs the report generating filter to search the patient record 200, the master medical library 300, and the user profile 100 for data specified by the template selected or the parameters selected within the report generating filter 500. Accordingly, customized administration and history reports 600 may be generated in a plurality of formats such as those specified above. This ability to generate customized reports is yet another great advance over the current art made by the instant invention. Previous methods of tracking medication that use hard media, such as preprinted cards, to display medications are invariably highly limited as to the manner of reports which are produced. In the instant invention, there is almost no limit to the number and types of reports which maybe generated, and new types of reports can be enabled, as needed, with relatively simple upgrades to the software of the method 50.

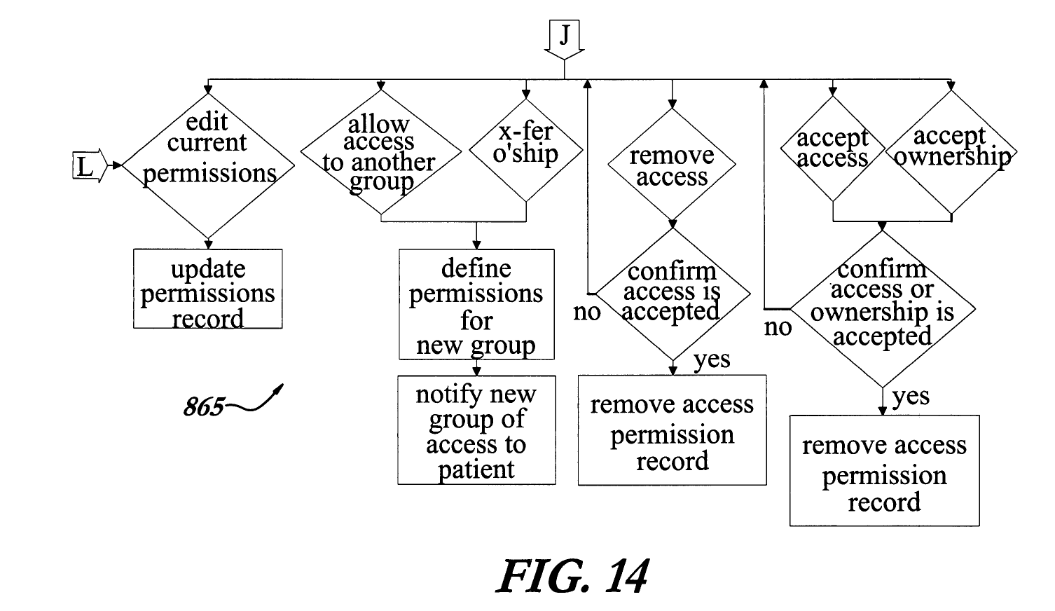

To enable different access privileges, the permission module is split between a Patient Permission Module 860 seen in FIG. 13 and a Group Permission Module 865, seen in FIG. 14. If, at the Menu Module 820, seen in FIG. 8, the user does not select the default Patient Module 830 seen in FIG. 9, but instead selects the Group Module 850, seen in FIG. 12, the user will be directed to the Group Manager Mode, which will, subject to access permission level assignment 112 as determined in the Group Permission Module 865, seen in FIG. 14, and the Patient Permission Module 860 seen in FIG. 13, be able to add, delete, copy, and edit information pertaining to users and groups.

For example, in the Group Module 850, as seen in FIG. 12, if the access permission level assignment 112 permits access to the Group Manager Mode, the user will have access to both group and individual user information. The user in Group Manager Mode will be able to edit and update group contact information. Entering the Users Mode, seen in FIG. 14, the user will, again subject to permissions granted by the access permission level assignment 112, be able to list users and copy, add, delete, and edit information. The editable information may extend to the ability to delete users and data from the method 50. Additionally, access permission level assignments 112 may be edited, as seen in FIGS. 13 and 14, to allow greater access, limit access, or to transfer ownership of a user profile 100 to a different group.

The integrity of the method 50 is protected by the utilization of access permission level assignments 112 as previously discussed, and as validated both as to Patient Permissions and User Permission, as seen in one embodiment in FIGS. 13 and 14. Subject to appropriate access permission level assignment 112; a user may enter the Patient Permissions Module 860, as seen in FIG. 13. This allows, among other functions, editing of permissions to grant access to other groups. Within the Patient Permissions Module 860, seen in FIG. 13, ownership may be transferred, and if ownership is accepted by another group, the transfer of the ownership of a patient record 200 may be made to another group. Similarly, subject to appropriate access permission level assignment 112, a user may enter the Patient Permissions Module 860, seen in FIG. 14. This allows the editing of permissions to grant access to other groups, and if ownership is accepted by another group, to transfer the ownership of a user profile 100 to another group.

Editing of various information within the method 50 is controlled, subject to access permission level assignments 112, by the Basic Editor Module 840, as seen in one embodiment in FIG. 11. The Basic Editor Module may be accessed at various points in the method 50, and may be seen in FIG. 12 as part of the Group Module 850. As part of the Group Module 850, the Basic Editor Module controls, as further seen in FIG. 12, such functions as being able to edit membership in various groups such that patient records 200 will be accessible, through at least the read-only limiter 114 to selected physicians, to other health care providers and institutions, pharmacies, insurance groups, and others.

Another important application of the Basic Editor Module 840, seen in FIG. 11, is for the editing of custom prescribed medications 222 into the patient medication profile 220. It is contemplated that while the master medication library 300 will be substantially comprehensive as to commercially available medications, and that it will be periodically updated with new or changed medication formulations, it will occasionally be necessary to add medications to the patient medication profile 220 that are not part of the master medication library 300. A user may, through the Basic Editor Module 840, be able to add custom prescribed medications 222 to the patient medication profile 220 contained in the patient record 200 by manually inputting information concerning that prescribed medication 222.

In sum, the instant invention enables numerous significant improvements in the art. Notably among these are the ability to maintain and disseminate an absolutely up to the minute and comprehensive master medication library 300, the ability to organize various aspects of a plurality of patient records 200 into groups having differing levels of access to information contained in those patient records 200, and the ability to generate a nearly limitless variety of administration history reports 600, which can be customized so as to best meet the needs and wishes of those using the method 50.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

1. An interactive multi-user medication and medical history management method, comprising the steps of:
creating at least one user profile by entering a plurality of user data;
generating at least one patient record including a patient medical history and a patient medication profile having at least one prescribed medication, at least one medication formulation requirement, and at least one medication administration requirement, wherein the patient medication profile is created in part by accessing a predetermined master medication library, resident in at least one memory medium, having a plurality of medication data for a plurality of medications, including at least one pictorial representation of each of the plurality of medications;
storing the at least one user profile and the at least one patient record and the master medication library on the at least one memory medium;
applying a user specified report generating filter to the at least one patient record to create at least one administration and history report; and
displaying the at least one administration and history report.

2. The method of claim 1, wherein the at least one memory medium wherein the predetermined master medication library resides is located in a first computer system in communication with a separate and distinct second computer system wherein the user profile creation step is initiated, wherein the report generating filter applying step is initiated, and wherein the displaying step occurs.

3. The method of claim 2, wherein the first computer system and the second computer system are in communication over the Internet.

4. The method of claim 1, wherein the user data includes at least one access permission level assignment for each of the at least one user profiles thereby associating any of the at least one patient records with any of the at least one access permission level assignments thereby permitting a user, associated with the user data, to access only the at least one patient records associated with the at least one access permission level assignment.

5. The method of claim 4, wherein the at least one permission level assignment includes at least one read-only limiter, associated with at least a portion of the at least one patient record, to enable a user to view the at least one patient records associated with the at least one access permission level assignment, but guard the permitted patient records from modification by the user.

6. The method of claim 1, wherein the at least one administration and history report includes at least one pictorial representation of each of the at least one prescribed medication.

7. The method of claim 1, wherein the at least one administration and history report includes at least one administration indicia.

8. The method of claim 7, wherein the at least one administration indicia is representative of a time of day that the at least one prescribed medication is preferably administered.

9. The method of claim 7, wherein the at least one administration indicia is representative of a method of administration.

10. The method of claim 1, wherein the at least one administration and history report is adapted for ease of use and handling, and is sized to fit in a wallet.

11. The method of claim 1, wherein the at least one administration and history report is adapted to be printed on a medication bottle sticker.

12. The method of claim 1, wherein the plurality of medication data for the plurality of medications includes a drug interaction profile for each of the plurality of medications.

13. The method of claim 12, wherein the user specified report generating filter compares the drug interaction profile of each of the at least one prescribed medication in the patient medication profile and displays at least one interaction warning indicia for any of the at least one prescribed medication known to interact with any other of the at least one prescribed medication in the patient medication profile.

14. The method of claim 1, further including the step of generating at least one medication refill reminder a predetermined number of days prior to the exhaustion of the at least one prescribed medication by utilizing the at least one medication formulation requirement and the at least one medication administration requirement.

15. The method of claim 14, wherein the at least one medication refill reminder is automatically emailed from the first computer system to the second computer system.

16. The method of claim 14, wherein the at least one medication refill reminder is automatically emailed from the first computer system to a site outside of the first and the second computer system.

17. The method of claim 1, wherein the patient medical history includes an allergy alert profile containing known allergies for each of the at least one patient records.

18. The method of claim 17, wherein the user specified report generating filter compares the allergy alert profile with each of the at least one prescribed medication and displaying allergy warning indicia for any of the at least one prescribed medication appearing in the allergy alert profile.

19. An interactive multi-user medication and medical history management method, comprising the steps of:
creating at least one user profile by entering a plurality of user data user data including at least one access permission level assignment for each of the at least one user profiles thereby associating any of the at least one patient records with any of the at least one access permission level assignments thereby permitting a user, associated with the user data, to access only the at least one patient records associated with the at least one access permission level assignment;
generating at least one patient record including a patient medical history wherein the patient medical history includes an allergy alert profile containing known allergies for each of the at least one patient records and a patient medication profile having at least one prescribed medication, at least one medication formulation requirement, and at least one medication administration requirement, wherein the patient medication profile is created in part by accessing a predetermined master medication library, resident in at least one memory medium, having a plurality of medication data for a plurality of medications, including a drug interaction profile for each of the plurality of medications and at least one pictorial representation of each of the plurality of medications;
storing the at least one user profile and the at least one patient record and the master medication library on the at least one memory medium;
applying a user specified report generating filter to the at least one patient record to create at least one administration and history report; and
displaying the at least one administration and history report wherein the at least one administration and history report includes at least one pictorial representation of each of the at least one prescribed medication and at least one administration indicia.

20. An interactive multi-user medication and medical history management method, comprising the steps of:
creating at least one user profile by entering a plurality of user data user data including at least one access permission level assignment wherein the at least one permission level assignment includes at least one read-only limiter, associated with at least a portion of the at least one patient record, to enable the user to view the at least one patient records associated with the at least one access permission level assignment, but guard the permitted patient records from modification by the user, for each of the at least one user profiles thereby associating any of the at least one patient records with any of the at least one access permission level assignments thereby permitting a user, associated with the user data, to access only the at least one patient records associated with the at least one access permission level assignment;
generating at least one patient record including a patient medical history wherein the patient medical history includes an allergy alert profile containing known allergies for each of the at least one patient records and a patient medication profile having at least one prescribed medication, at least one medication formulation requirement, and at least one medication administration requirement, wherein the patient medication profile is created in part by accessing a predetermined master medication library, resident in a first computer system in communication with a second separate and distinct computer system, the master medication library having a plurality of medication data for a plurality of medications, including a drug interaction profile for each of the plurality of medications and at least one pictorial representation of each of the plurality of medications;
storing the at least one user profile and the at least one patient record on the second computer system in communication with the first computer system containing the master medication library;
applying a user specified report generating filter in the second computer system to the at least one patient record to compare the drug interaction profile of each of the at least one prescribed medication in the patient medication profile and display at least one interaction warning indicia for any of the at least one prescribed medication known to interact with any other of the at least one prescribed medication in the patient medication profile and to compare the allergy alert profile with each of the at least one prescribed medication and displaying allergy warning indicia for any of the at least one prescribed medication appearing in the allergy alert profile and to create at least one administration and history report; and
displaying the at least one administration and history report on the second computer system wherein the at least one administration and history report includes at least one pictorial representation of each of the at least one prescribed medication and at least one administration indicia representative of a time of day that the at least one prescribed medication is preferably administered.

21. The method of claim 20, wherein the pictorial representation of each of the at least one prescribed medications is in accurate scale and coloration to the at least one prescribed medication.
